(19) United States
(12) Patent Application Publication
(10) Pub. No.: US 2022/0001438 A1
(43) Pub. Date: Jan. 6, 2022

(54) BALL-LOCK PUNCH RETAINER INSERTS

(71) Applicant: Moeller Precision Tool, LLC, Wixom, MI (US)

(72) Inventor: David J. Moellering, Orchard Lake, MI (US)

(21) Appl. No.: 17/289,894

(22) PCT Filed: Jan. 23, 2019
(86) PCT No.: PCT/US19/14724

§ 371 Date: Apr. 29, 2021

Related U.S. Application Data
(60) Provisional application No. 62/754,632, filed on Nov. 2, 2018.

(51) Int. Cl. B21D 37/04; B21D 28/34; B26D 7/26; B26F 1/04; B26F 1/14

(52) U.S. Cl. CPC B21D 37/04; B21D 28/34; B26F 1/14; B26F 1/04; B26D 7/26

(57) ABSTRACT

A ball-lock tool retainer insert includes a retainer insert body having a generally flat top and bottom face and a generally elongated non-circular cross-section. A lower portion and an upper portion of the retainer insert body each have a constant cross-section with the upper portion cross-section being larger than the lower portion cross-section thereby forming an enlarged shoulder. The retainer insert body has a tool aperture with a constant cross-section extending from the top face to the bottom face for receiving a tool and an angle hole adjacent the tool aperture extending from the top face and partially extending into the tool aperture for holding a ball lock. The retainer insert body is adapted to be received by a retainer block having a generally elongated non-circular hole with a counterbore such that the enlarged shoulder of the retainer insert body fits into the counterbore.

### CROSS REFERENCE TO RELATED APPLICATION

This application is the U.S. National Stage of PCT/US2019/014724 filed Jan. 23, 2019, which claims priority to U.S. Provisional Patent Application Ser. No. 62/754,632, filed Nov. 2, 2018, the entire content of both are incorporated herein by reference in their entirety.

### FIELD OF THE INVENTION

The present invention relates to retainers for industrial punches and, in particular, to ball-lock punch retainer inserts. A ball-lock punch retainer insert utilizes an offset ball and spring mechanism next to the punch socket in the insert.

### BACKGROUND OF THE INVENTION

Current retainers often rely upon the ability of the user or customer to provide the accuracy of the punch hole and ball-lock combination. When manufacturing the ball-lock retainers, the punch hole and angle hole are precisely held to ten thousandths of an inch. Users and customers, like die shops, generally cannot control the tolerances as needed to make the product function properly. It would be advantageous to provide ball-lock insert assemblies adapted for mounting in customer-manufactured holder plates or retainer blocks.

US patent application 2007/0101849 to Moellering (“the '849 application”) is directed to an insertable ball-lock retainer. One embodiment of the insertable ball-lock retainer that the '849 application discloses an enlarged head insert having a punch hole and ball detent extending into the punch hole. In this embodiment, the base of the punch hole includes a counterbore and a dowel pin hole. An angle hole extends into the punch hole and is provided with a counterbore as well.

U.S. Pat. No. 6,679,147 to Chaulklin (the '147 patent) teaches an insertable ball-lock punch retainer having a cross-section shaped like a top view of a measuring spoon, including a circular aperture portion and an oblong lock-housing portion. The peripheral surface is tapered inwardly from top face to bottom face around the aperture portion only. The insertable ball-lock punch retainer of the '147 patent appears to not have an enlarged head and a constant cross-section.

U.S. Pat. No. 1,393,040 to Richard (the '040 patent) teaches a punch retainer formed with an annular flange at the upper end, which is secured against a punch plate 16 by means of a member fitting over the annular flange. A central aperture is formed in the retainer extending from the upper face to the bottom face of the retainer. An angled aperture for the ball and spring extends from the upper face partially into the central aperture. The cross section of the retainer is circular. Further, the '040 patent does not discuss a retainer block for accepting multiple retainers.

U.S. Pat. Nos. 1,621,811 and 1,938,440 are patents to the same inventor Richard as the '040 patent, each teaching a tool retainer similar to that of the '040 patent.

### SUMMARY OF THE INVENTION

The new insert designs simplify the manufacture of the insert holder to accommodate die shops which are not sophisticated enough to provide the precision alignment of the punch hole and ball-lock, allowing them to manufacture their own holder and still have the benefit of ball-lock mechanism. The insert holder may be a simple block of low alloy steel with counterbored oblong or teardrop holes, which can easily be produced by wire electro-discharge machining (EDM) or computer numerically controlled (CNC) milling processes. The new insert designs have the benefit of speeding the process of providing a punch hole location, which often happens during die and holder construction. By simply using EDM or CNC machinery for a non-circular hole in a new location, a new punch location is established and the obsolete hole is abandoned. The machining can be done even if the holder or retainer is in a hardened condition.

Inserts of this nature could be used quite advantageously in a variety of devices. For example, it is anticipated that these inserts would have particular utility in “permanent” (or “continuous’) punch presses. Permanent-type punch presses are well known in the art. These presses characteristically include a plurality of permanently-positioned punch stations, each adapted to perform a given punching or forming operation upon a workpiece that is conveyed sequentially from station to station. While the present invention is by no means limited to use with permanent-type punch presses, embodiments of this nature are expected to have particular advantage.

The present invention provides a new and improved retainer insert design which can be attached and removed in openings or holes formed in a retainer block. The present design incorporates a ball-lock tool retainer insert with a non-tapered non-circular body and an enlarged head. The retainer insert body has a generally flat top and bottom face and a sidewall. The sidewall has a generally elongated non-circular cross-section. A lower portion and an upper portion of the retainer insert body each have a constant cross-section, with the upper portion cross-section being larger than the lower portion cross-section thereby forming an enlarged shoulder.

The retainer insert body may have a tool aperture with a constant cross-section extending from the top face to the bottom face of the retainer body for receiving a tool.

The retainer insert body may further have an angle hole adjacent the tool aperture extending from the top face and partially extending into the tool aperture for holding a ball lock. The ball-lock may include a ball and spring. The retainer insert body is adapted to be received by a retainer block having a generally elongated non-circular hole with a counterbore such that the enlarged shoulder of the retainer insert body fits into the counterbore.

In one embodiment, the sidewall has a teardrop-shaped cross section and the hole of the retainer block is teardrop-shaped.

The present invention further provides a ball-lock tool retainer system, which includes at least one ball-lock tool retainer insert in accordance with an embodiment of the present invention and a retainer block having at least one generally elongated non-circular recess with a counterbore defined therein to snugly receive the at least one ball-lock tool retainer insert. The counterbore is designed to engage the enlarged shoulder of the at least one ball-lock tool retainer insert such that the at least one ball-lock tool retainer insert does not fall through the generally elongated non-circular recess. The ball-lock tool retainer system further includes a backing plate adapted to be affixed to the retainer block such that the at least one ball-lock tool retainer insert, the ball lock and the tool are kept in place.

In some embodiments, the retainer block includes more than one generally elongated non-circular recess with a counterbore defined therein.

The retainer block may further include a plurality of screw holes adapted to each receive a screw for holding the backing plate to the retainer block.

### BRIEF DESCRIPTION OF THE DRAWINGS

FIG. 1 is a top plan view of a teardrop shaped punch retainer insert in accordance with the an embodiment of the present invention;

FIG. 2 is a side cross-sectional view of the insert in FIG. 1;

FIG. 3 is a perspective view of the insert in FIG. 1;

FIG. 4 is a top plan view of a rectangular block with teardrop shaped inserts;

FIG. 5 is a side cross-sectional view taken along the line 4-4 in FIG. 4; and

FIG. 6 is an exploded view of a punch retainer assembly.

### DETAILED DESCRIPTION OF THE INVENTION

The present invention provides a new and improved retainer insert design which can be attached and removed in openings or holes formed in a retainer block. The present design incorporates a non-tapered non-circular insert with an enlarged head. The insert completely encloses the punch socket and angle hole ball associated with a ball-lock punch retainer. Examples of the non-circular shapes of the insert may include oblong, teardrop, oval or any other suitable shape.

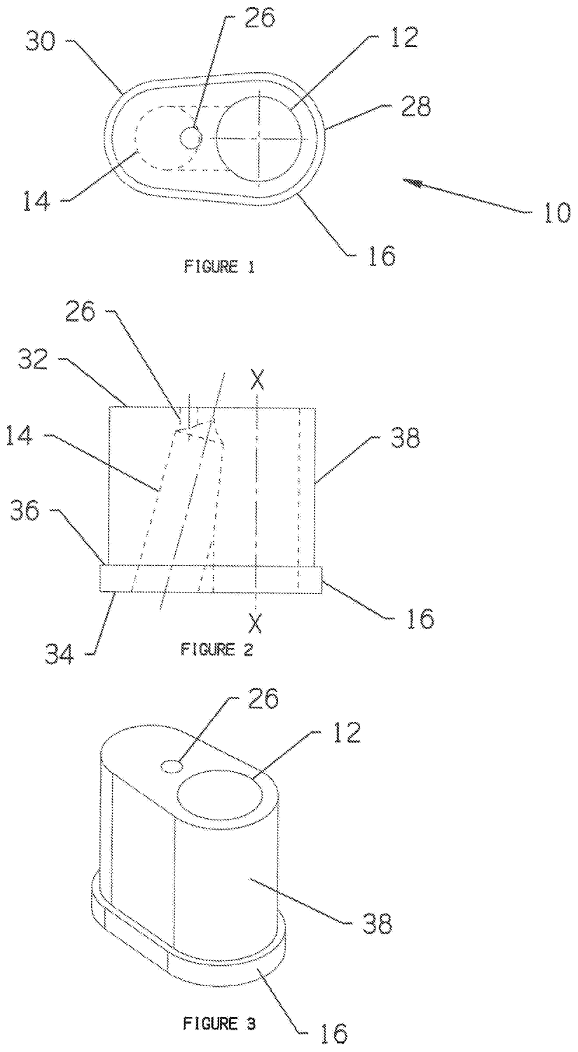

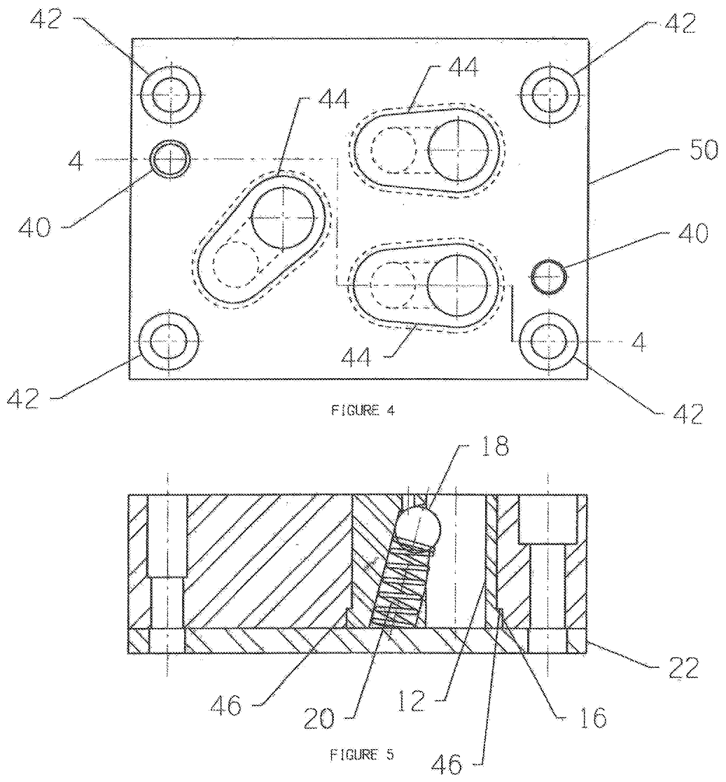

FIGS. 1-3 show a teardrop-shaped insert 10 in accordance with one embodiment of the present invention. The insert 10 includes a punch hole or socket 12 on one side and an angle hole 14 adjacent to the punch hole 12 on the other side and partially extending into the punch hole 12. The angle hole is for housing a ball-lock mechanism. The ball-lock may be a ball and a spring mechanism, which are not shown in FIGS. 1-3. The insert 10 in FIG. 1-3 may be called an insert body. The insert body along with the ball and the spring mechanism create a complete insert. However, for simplicity, the insert body 10 is referred as the insert throughout this application.

Referring to FIG. 2, the insert 10 has a generally flat top surface 32 and a generally flat bottom surface 34. The cross-section of a top plan view of the insert may be a teardrop, oblong shape, oval or other suitable shape. The angle hole 14 may have a generally fixed width for various inserts. The width of the punch hole 12 may vary depending on the sizes of the punches. For a smaller punch, the insert can be oblong shaped. For a larger punch, the size of the punch hole is larger forcing the side 28 of the insert with the punch hole to be larger than the side 30 with the ball, thereby appearing to be a teardrop shape. The teardrop shape may vary depending on the size of the punch. A non-circular shape can prevent the rotation of the retainer after being inserted in the retainer block. Some non-circular shapes such as a teardrop shape can also ensure the retainer insert to be insertable only in one orientation for a particular hole in the retainer block.

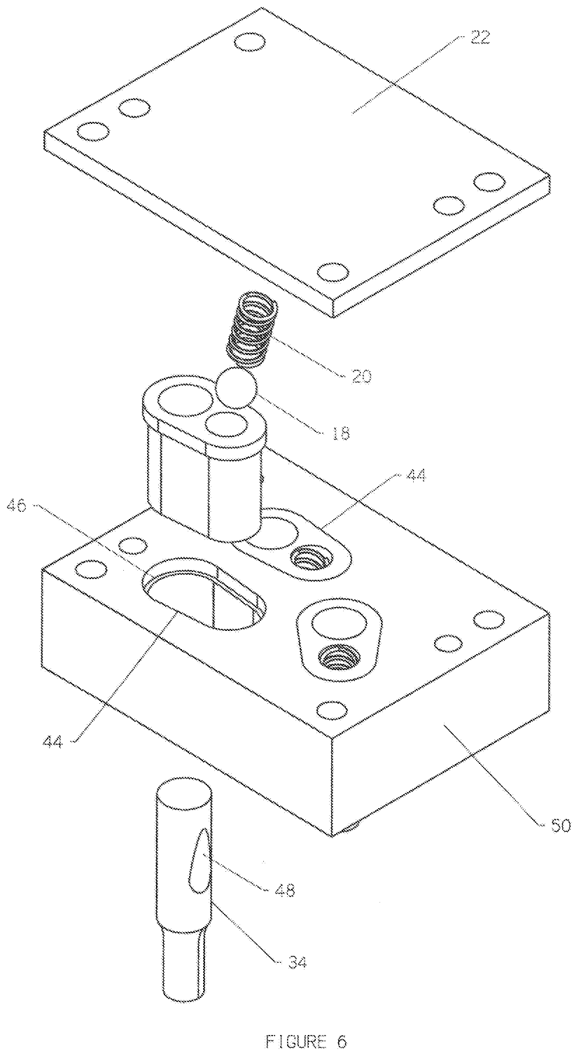

The side wall 38 of the insert is generally vertical. The side cross-sectional view of the insert 10 appears to be rectangular with an enlarged head 16. As shown in FIG. 2, the width of the punch hole 12 is constant extending from the top 32 to the bottom 34. The punch hole 12 is generally perpendicular to the top 32 and the bottom 34. The angle hole 14 is positioned at an angle with respect to the x-x direction thus appearing to be leaning into the punch hole 12. The part of the angle hole 14 which is leaning into the punch hole 12 is to house the ball 18, which will be described referring to FIG. 5 hereinbelow. The bottom of the insert 10 is enlarged relative to the top 32 forming the enlarged portion or head 16 of the side wall 38 adjacent the bottom and a peripheral shoulder 36.

As shown in FIG. 1, the cross section of the head 16 in a top plan view has a shape similar to the remainder of the insert. As shown in FIG. 2, the cross section of the head 16 from a side view appears rectangular. However, the top plan view cross section of the head or shoulder may be a different shape than the cross sectional shape of the top of the insert. The top plan view cross section of the head or shoulder may be any shape, including circular or square or other.

FIGS. 4-6 illustrate one embodiment of the present invention, wherein there is provided a retainer assembly 50 having multiple inserts, each insert being in accordance with an embodiment of the present invention, as described hereinabove. FIG. 6 provides an exploded view of the retainer assembly, along with a tool 24 to be inserted into the punch hole. The retainer assembly 50 may be adapted to removably retain the tool 24 in its operative position. The tool 24 may be a punch, a piercing tool, or the like. In its operative position, the tool 24 is adapted to perform a punching or forming operation upon a workpiece (e.g., a piece of sheet metal). The tool 24 may include a recess or detent 48 to engage the ball 18 when the tool is retained in the socket 12.

A block retainer or holder 50 is of generally rectangular shape and formed with several bolt holes 42 for attachment of the insert 10 to a backing plate 22. Also formed in the block 50 are dowel pin holes 40. Typically, the bolt holes 42 and dowel pin holes 40 are formed prior to heat treating of the block 50 and then finished for accuracy, if necessary, when the oblong or teardrop holes 44 are formed by using EDM or CNC methods. Several oblong or teardrop holes 44 can be formed in the same block, each with a different location and orientation. The customer could form any number of holes in any desired arrangement. This would allow the customer to readily manufacture retainer blocks configured to retain essentially any desired arrangement of tools.

To ensure correct functionality, both the socket hole and the angle hole must be manufactured to very tight tolerances. These improved insert designs of the present invention incorporate both holes completely integrated into the insert and are therefore completely under the control of the insert manufacturer.

In the example shown in FIG. 4, the insert holder 50 is formed with teardrop-shaped holes 44 to accept the enlarged head of the teardrop insert 10. The teardrop insert 10 has a punch hole or socket 12 and an angle hole 14. As shown in FIG. 5, the angle hole 14 encloses a resilient-biased engagement member 20 and a ball 8 placed at the top of the resilient-biased engagement member 20. Without a tool in the socket, the ball 18 is partially extending into the socket. When a tool is inserted into the socket 12 in its operational position, the resilient-biased engagement member 20 is urged into engagement with the shank of the tool 24 and the ball 18 will be urged to engage and cooperate with the recess or detent 48 of the tool 24. The resilient-biased engagement member 20 may be a spring or the like. The base of the socket 12 is locked in by a backing plate. The spring 20 is locked in by the backing plate as well. A relief hole 26 extends from the ball 14 to the top 32 of the insert 10. The relief hole 26 can be used to insert a removal tool (not shown) to move the ball out of engagement with the detent 48, allowing the tool to be removed from the socket.

When the teardrop-shaped insert 10 fits into the teardrop holes 44 of the insert holder 50, the shoulder 36 of the insert 10 will be received by a counterbore 46 in the hole 44 to lock in the enlarged head 16 when the insert is fastened to a backing plate 22.

The teardrop configuration prevents any reverse insertion of the insert in the holder which can happen with the oblong insert in its holder.

The retainer assembly 50 can be attached to a mounting plate (not shown) of a punch press in any desired manner. For example, a series of dowel pins may be used for attachment of the retainer assembly to a punch press. Alternatively, a series of cap screws can be used.

It is advantageous to mount the present retainer assembly 50 to a permanent-type punch press. As noted above, permanent-type punch presses characteristically include a plurality of permanently-positioned punch stations, each adapted to perform a given punching operation upon a workpiece that is conveyed sequentially from station to station. Thus, one embodiment of the invention provides a permanent-type punch press to which is mounted a retainer assembly 50 of the nature described herein.

While the insert has been discussed herein as oblong or teardrop, other non-circular shapes may also be used, such as square, rectangular, triangular or other shapes which avoid rotation after insertion. For some embodiments it is preferred that the shape allow insertion in only one orientation. For example, a teardrop shape limits insertion to one orientation while a symmetrical oblong does not. The head on the insert may have a matched shape or use a different shape. For some embodiments, a teardrop or oblong shape is preferred for the main portion of the insert and may be preferred for the head.

As will be clear to those of skill in the art, the embodiments of the present invention illustrated and discussed herein may be altered in various ways without departing from the scope or teaching of the present invention. Also, elements and aspects of one embodiment may be combined with elements and aspects of another embodiment. It is the following claims, including all equivalents, which define the scope of the invention.

1. A ball-lock tool retainer insert, comprising:
a retainer insert body having a generally flat top and bottom face and a sidewall, the sidewall having a generally elongated non-circular cross-section, a lower portion and an upper portion of the retainer insert body each having a constant cross-section, the upper portion cross-section being larger than the lower portion cross-section thereby forming an enlarged shoulder;
the retainer insert body having a tool aperture for receiving a tool, the aperture having a constant cross-section extending from the top face to the bottom face of the retainer body; and
the retainer insert body further having an angle hole adjacent the tool aperture for holding a ball lock, the angle hole extending from the top face and partially extending into the tool aperture;
wherein the retainer insert body is adapted to be received by a retainer block having a generally elongated non-circular hole with a counterbore such that the enlarged shoulder of the retainer insert body fits into the counterbore.

2. The ball-lock tool retainer insert according to claim 1, wherein the sidewall has a teardrop-shaped cross section and the hole of the retainer block is teardrop-shaped.

3. The ball-lock tool retainer insert according to claim 1, wherein the ball-lock includes a ball and spring.

4. A ball-lock tool retainer system, comprising:
at least one ball-lock tool retainer insert having a top surface, a bottom surface and a body, the body having a generally elongated non-circular cross section and having an aperture defined therein for receiving a tool, the aperture having a constant cross-section extending from the top surface to the bottom surface, the body having a lower portion adjacent the bottom surface having a larger cross-section than the other portion of the body thereby forming a flange;
a retainer block having at least one generally elongated non-circular recess with a counterbore defined therein to snugly receive the at least one ball-lock tool retainer insert, the counterbore designed to engage the flange of the at least one ball-lock tool retainer insert such that the at least one ball-lock tool retainer insert does not fall through the generally elongated non-circular recess; and
a backing plate, wherein the backing plate is adapted to be affixed to the retainer block such that the at least one ball-lock tool retainer insert, the ball lock and the tool are kept in place.

5. The ball-lock tool retainer system according to claim 4, wherein the body of the at least one ball-lock tool retainer insert has a teardrop-shaped cross section and the recess is teardrop-shaped.

6. The ball-lock tool retainer system according to claim 4, wherein the retainer block includes more than one generally elongated non-circular recess with a counterbore defined therein.

7. The ball-lock tool retainer system according to claim 4, wherein the retainer block includes a plurality of screw holes adapted to each receive a screw for holding the backing plate to the retainer block.
